(19) United States
(12) Patent Application Publication
(10) Pub. No.: US 2005/0139577 A1
(43) Pub. Date: Jun. 30, 2005

(54) Microelectromechanical system comb actuator and manufacturing method thereof

(76) Inventors: Sung-Chul Kim, Seoul (KR); Yong-Seop Yoon, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 10/479,865

(22) PCT Filed: Feb. 3, 2003
(86) PCT No.: PCT/KR03/00234

(30) Foreign Application Priority Data
Aug. 30, 2002 (KR) 10-2002-0051882

(51) Int. Cl. B44C 1/22

(52) U.S. Cl. 216/41

(57) ABSTRACT

A microelectromechanical system (MEMS) comb actuator materialized in an insulating material and a manufacturing method thereof are provided. The MEMS comb actuator includes a stationary comb fixed to a substrate; a movable comb separated from the substrate; a post fixed to the substrate; and a spring connected to the post to be separated from the substrate so as to movably support the movable comb. The stationary comb, the movable comb, the post, and the spring are formed in an insulating material layer formed on the substrate, and a metal coating layer is formed at least on the surface of the stationary comb and the movable comb. The method includes preparing a substrate; forming an insulating material layer on the substrate using silica or polymer; and selectively etching the insulating material layer and the substrate, thereby forming a stationary comb, a movable comb, a post, and a spring in the insulating material layer, and forming a metal coating layer on the surfaces of the stationary comb and the movable comb.

### TECHNICAL FIELD

The present invention relates to a microelectromechanical system (MEMS), and more particularly, to a MEMS comb actuator materialized in an insulating material and a manufacturing method thereof.

### BACKGROUND ART

Recent rapid development of surface micro-machining technology leads to development of MEMS apparatuses having various functions. MEMS apparatuses have many advantages in terms of size, cost, and reliability and have thus been developed for comprehensive applications.

In particular, as an interest in optical communication systems increases, technology concerning optical communication apparatuses or devices widely used in a communication network has been actively developed. With such development of optical communication technology, MEMS apparatuses are increasingly used in order to endow functions to optical communication devices. More specifically, at present, many techniques of materializing a planar lightwave circuit (PLC), i.e., an optical circuit integrated on a substrate, have been developed. These techniques are forming various types of waveguides replacing existing optical fiber in a very small region of a silica or polymer layer formed on a silicon substrate. At an early stage, these techniques were usually used to manufacture an arrayed waveguide grating (AWG), which is an optical device dividing a wavelength and mixing wavelengths in a wavelength division multiplexing (WDM) system. Recently, techniques of manufacturing a combined device by combining an AWB device with functional devices, such as an optical attenuator and an optical switch, have been developed. A MEMS actuator is widely used to drive the optical attenuator and the optical switch.

FIG. 1 shows an example of a conventional MEMS comb actuator applied to an optical device. Referring to FIG. 1, an optical switch 10 includes a plurality of waveguides 12a, 12b, 12c, and 12d and a reflective mirror 14, which is disposed among the plurality of waveguides 12a, 12b, 12c, and 12d to reflect light transmitted through the waveguides 12a, 12b, 12c, and 12d, thereby changing the traveling path of the light. When the reflective mirror 14 is moved in an arrow direction R and thus displaced from a position among the waveguides 12a, 12b, 12c, and 12d, light from the first waveguide 12a is directly incident on the fourth waveguide 12d, and light from the second waveguide 12b is directly incident on the third waveguide 12c. Conversely, when the reflective mirror 14 is moved in an arrow direction F, light from the first and second waveguides 12a and 12b is reflected from the reflective mirror 14, and thus the traveling path of the light is changed toward the third and fourth waveguides 12c and 12d.

The rectilinear motion of the reflective mirror 14 is carried out by a MEMS comb actuator 20 combined with the reflective mirror 14. The MEMS comb actuator 20 includes two combs 22 and 24, which are electrically is separated from each other. One of the two combs 22 and 24, for example, the comb 22, is a stationary comb fixed to a substrate. The other, for example, the comb 24, is a movable comb separated from the substrate. The movable comb 24 is supported by a spring 28 connected to a post 26 fixed to the substrate.

When a voltage is applied to the two combs 22 and 24 structured as described above, the movable comb 24 supported by the spring 28 is pulled down to the fixed comb 22 due to static electricity. However, due to the elasticity of the spring 28, the movable comb 24 does not closely contact the fixed comb 22 but is separated from the fixed comb 22 by a predetermined gap. When the voltage applied to the two combs 22 and 24 is cut off, the movable comb 24 returns to its original position due to the force of restitution of the spring 28. With such rectilinear motion of the movable comb 24, the reflective mirror 14 combined with the movable comb 24 rectilinearly moves in the arrow direction F or R. Here, the moving distance of the movable comb 24 and the reflective mirror 14 can be adjusted by adjusting the magnitude of the voltage applied to the two combs 22 and 24.

FIGS. 2A through 2D show processes of manufacturing the conventional MEMS comb actuator shown in FIG. 1. Referring to FIG. 2A, the conventional MEMS comb actuator is usually manufactured using a Silicon On Insulator (SOI) wafer 30, in which an insulating layer 33 is formed between two silicon substrates 31 and 32. The SOI wafer 30 is manufactured by forming the insulating layer 33 made of silicon oxide on the first silicon substrate 31 and then bonding the second silicon substrate 32 to the insulating layer 33. Thereafter, as shown in FIG. 2B, photoresist is deposited on the second silicon substrate 32 and then patterned, thereby forming an etch mask 42. Next, as shown in FIG. 2C, the first silicon substrate 32 is etched through the etch mask 42, thereby forming trenches 44, and then the etch mask 42 is removed. Next, as shown in FIG. 2D, the exposed insulating layer 33 made of silicon oxide is etched through the trenches, thereby forming a silicon structure 34 separated from the first silicon substrate 31.

As described above, the conventional MEMS comb actuator is constituted by a conductive silicon structure because in order to apply a voltage to a stationary comb and a movable comb of the MEMS comb actuator, the materials of the stationary and movable combs must have conductivity. In the meantime, as described above, a waveguide is formed on an insulating material layer, such as a silica layer or polymer layer, formed on a silicon substrate. When the material of the MEMS comb actuator is different from that of the waveguide passing light therethrough, it is difficult to integrally construct the MEMS comb actuator and a waveguide portion on a single substrate. Conventionally, therefore, a hybrid technique of forming a functional optical device such as an optical switch driven by the MEMS comb actuator by separately manufacturing the MEMS comb actuator and the waveguide portion and then combining them.

However, according to the hybrid technique, manufacturing processes of the MEMS comb actuator and the waveguide portion must be separately carried out, and a process of combining them is additionally needed, so manufacturing cost increases. Moreover, an alignment error may occur when the MEMS comb actuator is combined with the waveguide portion, thereby degrading performance.

In the meantime, when optical fiber is used instead of a waveguide, the optical fiber is aligned and combined with the MEMS structure made of silicon. In this case, manufacturing cost also increases due to alignment of the optical fiber, and an alignment error also occurs. In addition, reliability can be decreased as time lapses and temperature changes.

### DISCLOSURE OF THE INVENTION

The present invention provides a microelectromechanical system (MEMS) comb actuator materialized in an insulating material, such as silica or polymer, so that the MEMS comb actuator can be integrally formed with an optical device on a single substrate.

The present invention also provides a method of manufacturing a MEMS comb actuator using an insulating material such as silica or polymer.

According to an aspect of the present invention, there is provided a MEMS comb actuator including a stationary comb, which is fixed to a substrate; a movable comb, which is separated from the substrate; a post fixed to the substrate; and a spring, which is connected to the post to be separated from the substrate so as to movably support the movable comb. The stationary comb, the movable comb, the post, and the spring are formed in an insulating material layer formed on the substrate, and a metal coating layer having conductivity is formed at least on the surface of the stationary comb and the movable comb.

Preferably, the insulating material layer is made of silica or polymer, the metal coating layer is made of one of aluminum and gold, and the substrate is a silicon substrate.

The metal coating layer may be formed on the top and side surfaces of each of the stationary comb and the movable comb. Preferably, the metal coating layer formed on the surface of the movable comb extends across the surfaces of the spring and the post.

According to another aspect of the present invention, there is provided a method of manufacturing a MEMS comb actuator. The method includes (a) preparing a substrate; (b) forming an insulating material layer having a predetermined thickness on the substrate; and (c) selectively etching the insulating material layer and the substrate, thereby forming a stationary comb fixed to the substrate, a movable comb separated from the substrate, a post fixed to the substrate, and a spring connected to the post to be separated from the substrate so as to movably support the movable comb in the insulating material layer, and forming a metal coating layer having conductivity on the surfaces of the stationary comb and the movable comb.

Step (c) includes forming an etch mask on the top of the insulating material layer; etching the insulating material layer exposed through the etch mask, thereby forming trenches; etching the substrate through the trenches to a predetermined depth, thereby forming structures separated from the substrate in the insulating material layer; and forming the metal coating layer.

Alternatively, step (c) includes forming an etch mask on the top of the insulating material layer; etching the insulating material layer exposed through the etch mask, thereby forming trenches; forming a metal coating layer at least on the surfaces of portions, which constitute the stationary comb and the movable comb; etching the metal coating layer formed on the bottoms of the trenches to expose the substrate; and etching the substrate to a predetermined depth, thereby forming structures separated from the substrate in the insulating material layer.

The insulating material layer may be made of silica. In this case, the insulating material layer can be formed using flame hydroxide deposition (FHD) and can be etched using reactive ion etching (RIE).

The insulating material layer may be made of a polymer. In this case, the insulating material layer can be formed using at least one method selected from the group consisting of laminating, spray coating, and spin coating and can be etched using photolithography.

The substrate may be etched using wet etch.

Preferably, the metal coating layer is made of one of aluminum and gold. In this case, the metal coating layer can be formed using chemical vapor deposition (CVD) or a sputtering process.

According to the present invention, a MEMS comb actuator can be integrally formed with an optical device formed in an insulating material, such as silica or polymer, on a single substrate, so totals of manufacturing time and cost are reduced. In addition, an alignment error does not occur.

### BRIEF DESCRIPTION OF THE DRAWINGS

FIG. 1 is a plane view of an example of a conventional microelectromechanical system (MEMS) comb actuator applied to an optical device.

FIGS. 2A through 2D are diagrams showing the stages in a method of manufacturing the conventional MEMS comb actuator shown in FIG. 1.

FIG. 3 is a plane view of a MEMS comb actuator according to a preferred embodiment of the present invention.

FIG. 4 is a partial perspective view of the MEMS comb actuator taken to along the line A-A′ shown in FIG. 3.

FIGS. 5A through 5E are sectional views of the stages in a method of manufacturing a MEMS comb actuator according to a first preferred embodiment of the present invention, which are taken along the line B-B′ shown in FIG. 3.

FIGS. 6A and 6B are sectional views of the stages in a method of manufacturing a MEMS comb actuator according to a second preferred embodiment of the present invention, which are taken along the line B-B′ shown in FIG. 3.

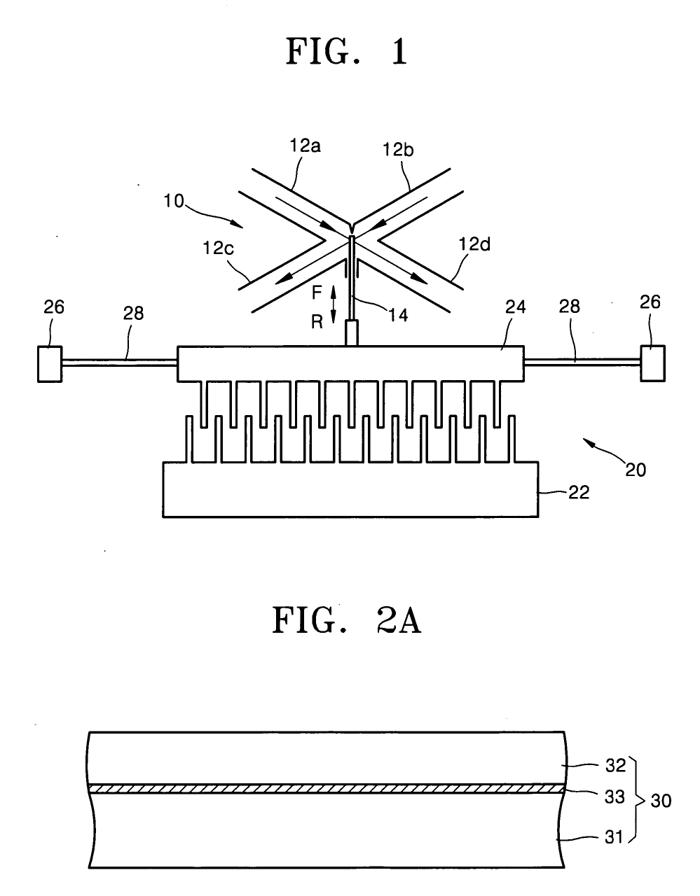

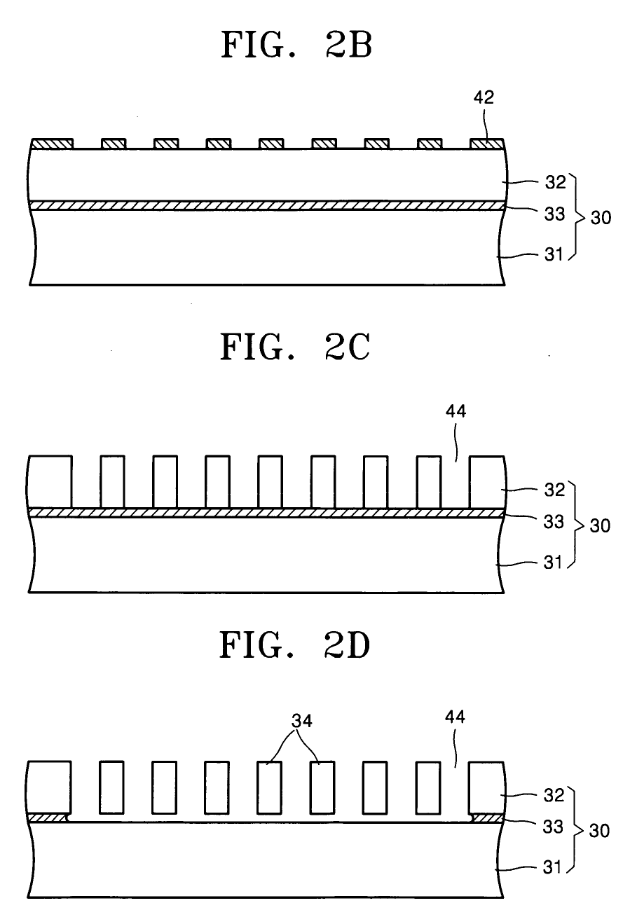

### BEST MODE FOR CARRYING OUT THE INVENTION

Hereinafter, preferred embodiments of the present invention will be described in detail with reference to the attached drawings.

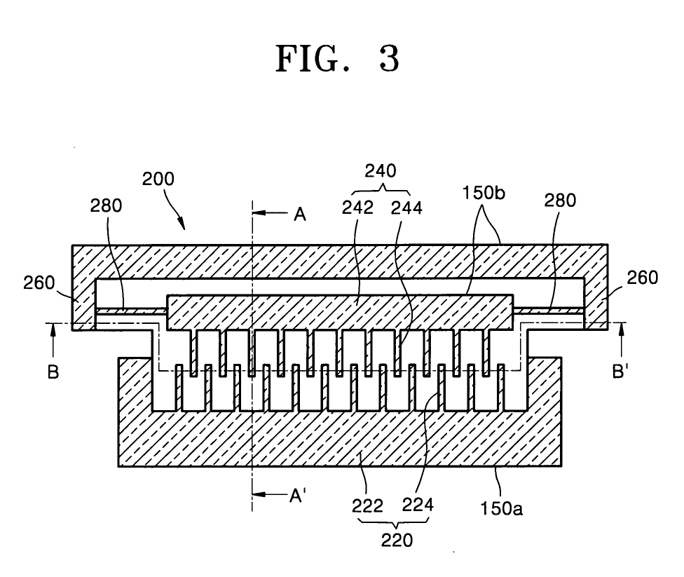

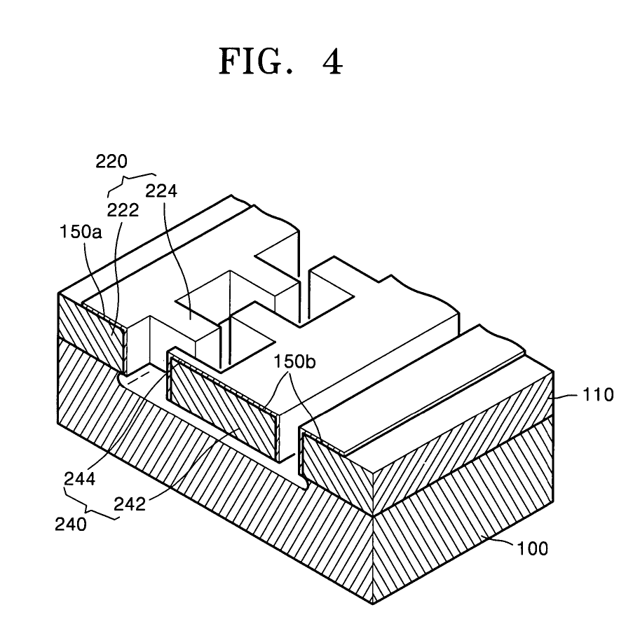

FIG. 3 is a plane view of a microelectromechanical system (MEMS) comb actuator according to a preferred embodiment of the present invention. FIG. 4 is a partial perspective view of the MEMS comb actuator taken along the line A-A′ shown in FIG. 3.

Referring to FIGS. 3 and 4, a MEMS comb actuator 200 according to the present invention is formed on and supported by a silicon substrate 100. The silicon substrate 100 can be replaced with a substrate, for example, a glass substrate, which is made of an easily processible material. The MEMS comb actuator 200 includes a stationary comb 220, a movable comb 240, posts 260, and springs 280.

The stationary comb 220 is composed of a stationary stage 222 fixed to the silicon substrate 100 and a plurality of stationary fingers 224 protruding from one side of the stationary stage 222 in the shape of the teeth of a comb. The movable comb 240 is separated from the silicon substrate 100 by a predetermined gap to rectilinearly move. The movable comb 240 includes a movable stage 242 and a plurality of movable fingers 244 protruding from one side of the movable stage 242 in the shape of the teeth of a comb to face the stationary fingers 224. The stationary comb 220 and the movable comb 240 are physically and electrically separated from each other. The stationary fingers 224 and the movable fingers 244 are interlaced with each other with a predetermined gap.

The posts 260 are separated from the movable comb 240 and disposed at both sides, respectively, of the movable comb 240. The posts are fixed to the silicon substrate 100.

A spring 280 is disposed between each of the two posts 260 and the movable comb 240 and separated from the silicon substrate 100. In other words, the ends of the springs 280 are connected to the respective posts 260, and the other ends thereof are connected to the respective ends of the movable comb 240, so that the springs 280 elastically support the movable comb 240.

The stationary comb 220, the movable comb 240, the posts 260, and the springs 280 are formed on an insulating material layer 110 on the silicon substrate 100. In other words, the MEMS comb actuator 200 of the present invention is made of an insulating material. Various kinds of insulating material can be used, but it is preferable to use silica or polymer usually used to manufacture optical devices.

As described above, since the MEMS comb actuator 200 of the present invention is made of an insulating material such as silica, conductive metal coating layers 150a and 150b are formed at least on the surfaces of the respective stationary and movable combs 220 and 240 in order to apply a voltage to the stationary comb 220 and the movable comb 240. The metal coating layers 150a and 150b can be made of any conductive metal, but it is preferable to use aluminum or gold frequently used in semiconductor manufacturing processes. As shown in FIG. 4, the metal coating layers 150a and 150b can be formed on the top and side surfaces of the stationary comb 220 and the movable comb 240. The metal coating layers 150a and 150b are electrically connected to a bonding pad (not shown).

The metal coating layers 150a and 150b can be formed only on the surfaces of the stationary comb 220 and the movable comb 240. In this case, the metal coating layer 150b formed on the surface of the movable comb 240 is connected to the bonding pad through a wire (not shown), so the wire may snap due to the rectilinear movement of the movable comb 240. Accordingly, as shown in FIG. 3, it is preferable that the metal coating layer 150b formed on the surface of the movable comb 240 extends across the surfaces of the springs 280 and the posts 260. Here, the wire can be connected to a portion of the metal coating layer 150, which is formed on the surface of the posts 260 and thus does not move. In addition, the stationary stage 222 of the stationary comb 220 fixed to the silicon substrate 100 and the posts 260 fixed to the silicon substrate 100 can be defined by the metal coating layers 150a and 150b, respectively, formed on their surfaces.

In operation of the MEMS comb actuator 200 having the above-described structure according to the present invention, when a voltage is applied to the metal coating layers 150a and 150b formed on the surfaces of the stationary comb 220 and the movable comb 240, electrostatic power is generated between the metal coating layers 150a and 150b, and thus the movable comb 240 is drawn to the stationary comb 220. Here, the moving distance of the movable comb 240 can be adjusted by controlling the elasticity of the springs 280 and the magnitude of the voltage applied to the metal coating layers 150a and 150b. When the voltage applied to the metal coating layers 150a and 150b is cut off, the movable comb 240 returns to its original position due to the force of restitution of the springs 280.

As described above, although the MEMS comb actuator 200 of the present invention is made of an insulating material, such as silica or polymer, it can satisfactorily perform its function due to the metal coating layers 150a and 150b. Accordingly, the MEMS comb actuator 200 can be integrally formed with an optical device formed on an insulating material, such as a polymer or silica, on a single substrate.

The following description concerns preferred embodiments of a method of manufacturing a MEMS comb actuator having the above-described structure according to the present invention.

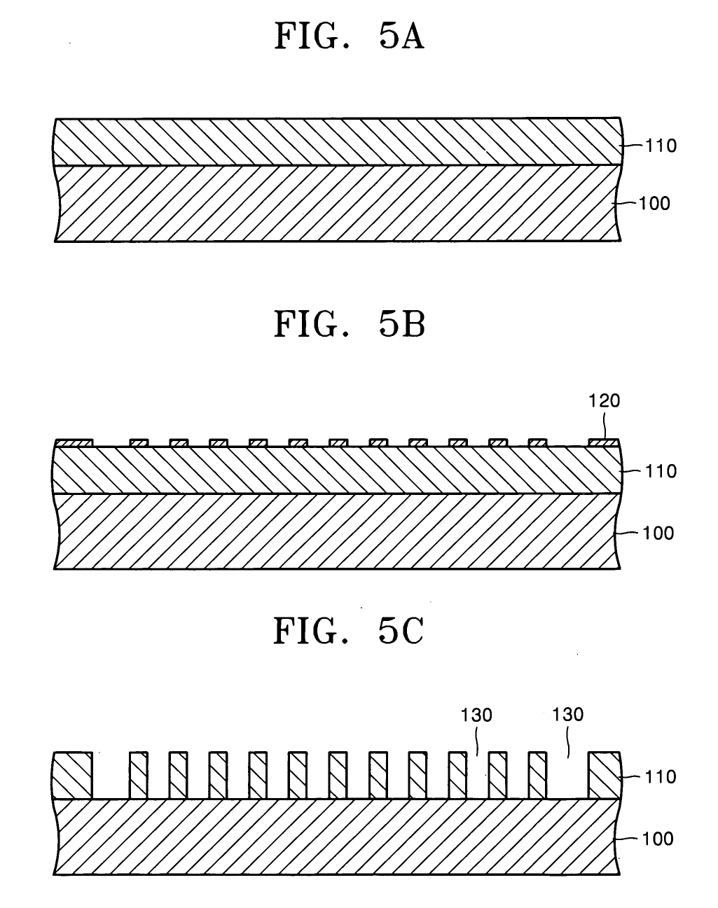

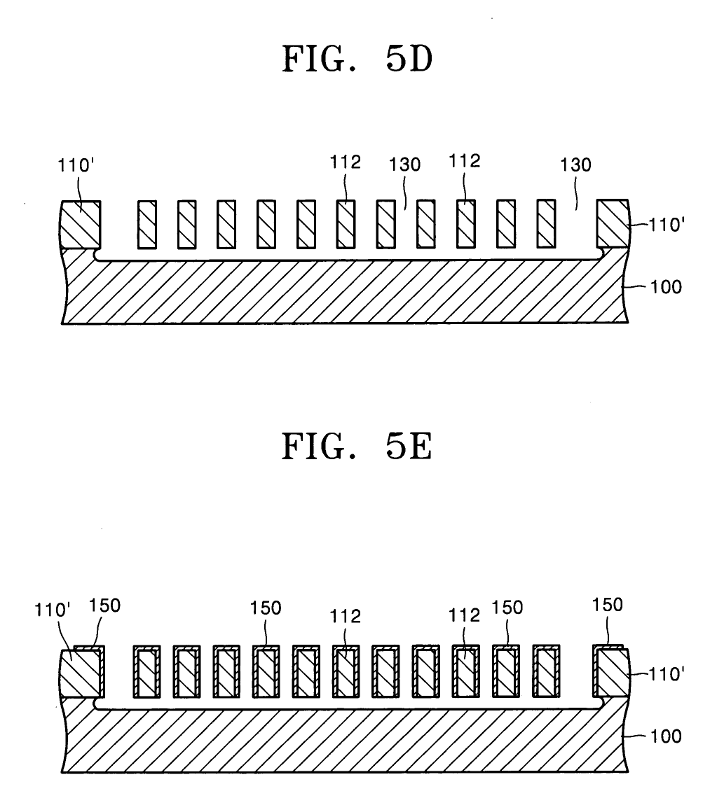

FIGS. 5A through 5E are sectional views of the stages in a method of manufacturing a MEMS comb actuator according to a first preferred embodiment of the present invention, which are taken along the line B-B′ shown in FIG. 3.

Referring to FIG. 5A, in the first embodiment, a silicon substrate 100 is prepared as a substrate supporting an MEMS comb actuator. Although a glass substrate instead of the silicon substrate 100 can be used, it is more effective for mass production to use the silicon substrate 100 since a silicon wafer widely used in manufacturing semiconductor devices can be used.

In the meantime, FIG. 5A shows only a part of a silicon wafer. Several tens through several hundreds of MEMS comb actuators according to the present invention can be formed on a single wafer in the form of chips.

Thereafter, an insulating material layer, for example, a silica layer 110, is formed on the top of the prepared silicon substrate 100 to a predetermined thickness. As described above, the insulating material layer can be formed of other insulating material, for example, a polymer, than silica. Hereinafter, it is assumed that the insulating material layer is the silica layer 110 made of silicon oxide, for example, SiO₂. More specifically, the silica layer 110 can be formed to have a thickness of about 40 μm using chemical vapor deposition (CVD) or flame hydrolysis deposition (FHD). It is preferable to use FHD, which is more advantageous in forming a relatively thick material layer.

In the meantime, when a polymer layer instead of the silica layer 110 is used as the insulating material layer, the polymer layer can be formed to a thickness of about 40 μm on the silicon substrate 100 using a method such as laminating, spray coating, or spin coating.

Next, referring to FIG. 5B, an etch mask 120 is formed on the top of the silica layer 110. The etch mask 120 can be formed by depositing photoresist on the top of the silica layer 110 and then patterning the photoresist.

Subsequently, the silica layer 110 exposed through the etch mask 120 is etched, thereby forming trenches 130, as shown in FIG. 5C. The silica layer 110 can be etched using dry etching such as reactive ion etching (RIE).

In the meantime, when the polymer layer instead of the silica layer 110 is used as the material layer, the structure shown in FIG. 5C can be formed using photolithography.

Next, referring to FIG. 5D, the silicon substrate 100 exposed through the trenches 130 is etched to a predetermined depth. More specifically, the silicon substrate 100 is wet etched to a thickness of about 5-10 μm using a silicon etchant, for example, tetramethyl ammonium hydroxide (TMAH) or KOH. As a result, silica structures 112 separated from the silicon substrate 100 are formed, as shown in FIG. 5D. Here, each silica structure 112 has a thickness of about 5 μm and a height of about 40 μm. The silica structures 112 are separated from one another by a distance of about 3-5 μm.

The silica structures 112 constitute the movable stage 242 and the movable fingers 244 of the movable comb 240 shown in FIG. 3 and a part of the stationary comb 220, i.e., the stationary fingers 224, shown in FIG. 3. Although not shown in FIG. 5D, the springs 280 shown in FIG. 3 are formed using such silica structures described above.

In FIG. 5D, silica layer portions 110′ remaining on the silicon substrate 100 form the posts 260 shown in FIG. 3. Although not shown in FIG. 5D, the stationary stage 222 of the stationary comb 220 shown in FIG. 3 is formed using such remaining portions of the silica layer 110 as described above.

Referring to FIG. 5E, a metal coating layer 150 having conductivity is formed on the surface of the resultant structure shown in FIG. 5D. More specifically, the metal coating layer 150 can be formed by depositing aluminum or gold on the surfaces of the remaining silica layer 110′ and the silica structures 112 to a thickness of about 0.5 μm using a CVD or sputtering process.

It is preferable to form the metal coating layer 150 only on the top and side surfaces of the remaining silica layer 1101 and the silica structures 112. Although the metal coating layer 150 can be formed only on the surfaces of portions constituting the stationary comb 220 of FIG. 3 and the movable comb 240, it is preferable to additionally form the metal coating layer 150 on the surfaces of portions constitute the springs 280 and the posts 260. As described above, this metal coating layer 150 can define the stationary stage 222 of the stationary comb 220 and the posts 260.

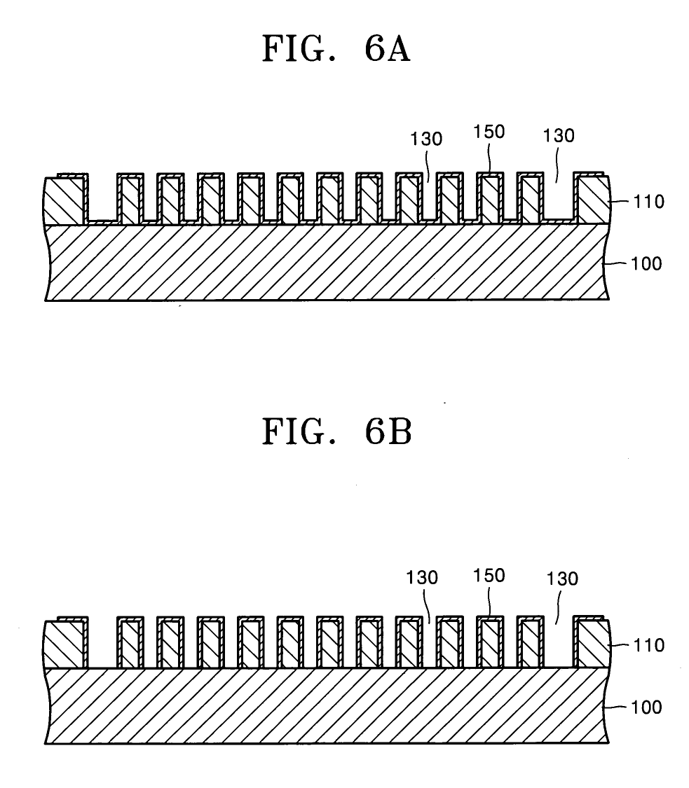

FIGS. 6A and 6B are sectional views of the stages in a method of manufacturing a MEMS comb actuator according to a second preferred embodiment of the present invention, which are taken along the line B-B′ shown in FIG. 3. In the second embodiment, the same stages as those of the first embodiment shown in FIGS. 5A through 5C are performed, and thus a description thereof will be omitted.

After forming the trenches 130 by etching the silica layer 110 on the silicon substrate 100 in the stage shown in FIG. 5C, the metal coating layer 150 is formed on the surface of the resultant structure, as shown in FIG. 6A. The metal coating layer 150 is formed on the same portions and in the same manner as in the first embodiment.

Thereafter, as shown in FIG. 6B, the metal coating layer 150 formed on the bottom of the trenches 130 is etched, thereby exposing the silicon substrate 100. Then, the silicon substrate 100 is etched to a predetermined depth, thereby forming the same structure as shown in FIG. 5E. The silicon substrate 100 is etched using the same etching method as that used in the first embodiment.

As described above, the manufacturing method according to the second embodiment of the present invention is almost the same as that according to the first embodiment of the present invention, with the exception that the metal coating layer 150 is formed before the silicon substrate 100 is etched.

According to a manufacturing method of the present invention, a MEMS comb actuator can be materialized in an insulating material, such as silica or polymer. Consequently, the MEMS comb actuator can be integrally formed with an optical device on a single substrate.

While this invention has been particularly shown and described with reference to preferred embodiments thereof, the preferred embodiments should be considered in descriptive sense only, and it will be understood by those skilled in the art that various changes in form and details may be made therein. For example, a MEMS comb actuator of the present invention can be made using various insulating materials in addition to silica and polymer. Instead of silicon, other easily processible materials can be used to make a substrate. In addition, in depositing and etching each layer, various deposition and etching methods not mentioned in the above-described embodiments can be used. The specific numerical values suggested in the description of the manufacturing methods can be freely adjusted within a range allowing a manufactured MEMS comb actuator to normally operate. Moreover, a MEMS comb actuator according to the present invention can be various technological fields as well as the field of optical communication including an optical switch and optical attenuator. Therefore, the scope of the invention is defined not by the detailed description of the invention but by the appended claims.

Industrial Applicability

As described above, according to the present invention, a MEMS comb actuator can be materialized in an insulating material, such as silica or polymer and thus can be integrally formed with an optical device formed in the insulating material on a single substrate. Therefore, a conventional process of separately manufacturing a MEMS comb actuator and an optical device part and combining them is not necessary, so totals of manufacturing time and cost are reduced. In addition, an alignment error does not occur. Consequently, high reliability of a functional optical device driven by a MEMS comb actuator can be achieved, and a competitive price can be secured.

1. A microelectromechanical system (MEMS) comb actuator comprising:
a stationary comb, which is fixed to a substrate;
a movable comb, which is separated from the substrate;
a post fixed to the substrate; and
a spring, which is connected to the post to be separated from the substrate so as to movably support the movable comb,
wherein the stationary comb, the movable comb, the post, and the spring are formed in an insulating material layer formed on the substrate, and a metal coating layer having conductivity is formed at least on the surface of the stationary comb and the movable comb.

2. The MEMS comb actuator of claim 1, wherein the insulating material layer is made of silica.

3. The MEMS comb actuator of claim 1, wherein the insulating material layer is made of a polymer.

4. The MEMS comb actuator of claim 1, wherein the metal coating layer is made of one of aluminum and gold.

5. The MEMS comb actuator of claim 1, wherein the metal coating layer is formed on the top and side surfaces of each of the stationary comb and the movable comb.

6. The MEMS comb actuator of claim 1, wherein the metal coating layer formed on the surface of the movable comb extends across the surfaces of the spring and the post.

7. The MEMS comb actuator of claim 6, wherein the stationary comb and the post are defined by the metal coating layer formed on their surfaces.

8. The MEMS comb actuator of claim 1, wherein the substrate is a silicon substrate.

9. The MEMS comb actuator of claim 1, wherein the MEMS comb actuator can be integrally formed with an optical device on the substrate.

10. A method of manufacturing a microelectromechanical system (MEMS) comb actuator, the method comprising:
(a) preparing a substrate;
(b) forming an insulating material layer having a predetermined thickness on the substrate; and
(c) selectively etching the insulating material layer and the substrate, thereby forming a stationary comb fixed to the substrate, a movable comb separated from the substrate, a post fixed to the substrate, and a spring connected to the post to be separated from the substrate so as to movably support the movable comb in the insulating material layer, and forming a metal coating layer having conductivity on the surfaces of the stationary comb and the movable comb.

11. The method of claim 10, wherein step (c) comprises:
forming an etch mask on the top of the insulating material layer;
etching the insulating material layer exposed through the etch mask, thereby forming trenches;
etching the substrate through the trenches to a predetermined depth, thereby forming structures separated from the substrate in the insulating material layer; and
forming the metal coating layer.

12. The method of claim 10, wherein step (c) comprises:
forming an etch mask on the top of the insulating material layer;
etching the insulating material layer exposed through the etch mask, thereby forming trenches;
forming a metal coating layer at least on the surfaces of portions, which constitute the stationary comb and the movable comb;
etching the metal coating layer formed on the bottoms of the trenches to expose the substrate; and
etching the substrate to a predetermined depth, thereby forming structures separated from the substrate in the insulating material layer.

13. The method of claim 10, wherein the substrate is a silicon substrate.

14. The method of claim 10, wherein the insulating material layer is made of silica.

15. The method of claim 14, wherein the insulating material layer is formed using flame hydroxide deposition (FHD).

16. The method of claim 14, wherein the insulating material layer is etched using reactive ion etching (RIE).

17. The method of claim 10, wherein the insulating material layer is made of a polymer.

18. The method of claim 17, wherein the insulating material layer is formed using at least one method selected from the group consisting of laminating, spray coating, and spin coating.

19. The method of claim 17, wherein the insulating material layer is etched using photolithography.

20. The method of claim 10, wherein the substrate is etched using wet etch.

21. The method of claim 10, wherein the metal coating layer is made of one of aluminum and gold.

22. The method of claim 10, wherein the metal coating layer is formed using chemical vapor deposition (CVD).

23. The method of claim 10, wherein the metal coating layer is formed using a sputtering process.

24. The method of claim 10, wherein the metal coating layer is formed on the top and side surfaces of each of the stationary comb and the movable comb.

25. The method of claim 10, wherein the metal coating layer formed on the surface of the movable comb extends across the surfaces of the spring and the post.

26. The method of claim 25, wherein the stationary comb and the post are defined by the metal coating layer formed on their surfaces.

27. The method of claim 10, wherein the MEMS comb actuator is integrally formed with an optical device on the substrate.
